(19) United States
(12) Patent Application Publication
(10) Pub. No.: US 2025/0240692 A1
(43) Pub. Date: Jul. 24, 2025

(54) REESTABLISHMENT WITH REDIRECTION FOR A NARROWBAND INTERNET OF THINGS DEVICE

(71) Applicant: Qualcomm Incorporated, San Diego, CA (US)

(72) Inventors: Bharat SHRESTHA, San Diego, CA (US); Alberto RICO ALVARINO, San Diego, CA (US); Umesh PHUYAL, San Diego, CA (US)

(21) Appl. No.: 18/419,467

(22) Filed: Jan. 22, 2024

(51) Int. Cl. H04W 36/30; H04W 36/08

(52) U.S. Cl. CPC H04W 36/305; H04W 36/08

(57) ABSTRACT

Certain aspects of the present disclosure provide techniques for performing a reestablishment procedure to redirect communications for a device from a first cell to a second cell. For example, a network entity may send a radio resource control (RRC) message to the device, and the RRC message may include an indication for the device to redirect the communications to the second cell. Subsequently, the device may perform a reestablishment procedure to redirect the communications to the second cell based on receiving the RRC message. In some embodiments, the RRC message may be an RRC release message that includes an IE used to indicate redirection of the communications to the second cell. Additionally or alternatively, the RRC message may be an RRC reestablishment message that includes an IE used to indicate the redirection. In some embodiments, the device may operate in a control plane Internet of Things (IoT) optimization mode.

### BACKGROUND

### Field of the Disclosure

Aspects of the present disclosure relate to wireless communications, and more particularly, to techniques for performing a reestablishment procedure with redirection.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving, via a first cell, a radio resource control (RRC) message comprising an indication to redirect communications via the first cell to a second cell; and performing a reestablishment procedure to redirect the communications to the second cell based at least in part on receiving the RRC message comprising the indication.

Another aspect provides a method for wireless communications by an apparatus. The method includes determining to redirect communications via a first cell to a second cell for a device; and sending, to the device via the first cell, an RRC message comprising an indication configured to trigger the device to perform a reestablishment procedure to redirect the communications to the second cell based at least in part on the determination.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example non-terrestrial network (NTN).

FIG. 6 depicts an example wireless communications system.

FIG. 7 depicts a process flow for communications in a network between one or more network entities and a narrowband (NB) Internet of Things (IoT) device.

FIG. 8 depicts a process flow for communications in a network between one or more network entities and an NB-IoT device.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for performing a reestablishment procedure with redirection.

Narrowband (NB) Internet of Things (IoT) can be used for various wireless communications systems (e.g., non-terrestrial networks (NTNs)) in which wireless devices are located in remote or hard to reach areas and/or are located long distances from a nearest cellular network entity. However, some NB-IoT devices (e.g., devices operating in a control plane Internet of Things (IoT) optimization mode) may not support handover and thus cannot be moved to a second carrier or cell from a first carrier or cell (e.g., for load balancing, cell mobility, establishing a higher quality connection, etc.). Accordingly, as described herein, techniques are provided to enable an NB-IoT device to redirect a wireless connection from the first carrier or cell (e.g., a source cell) to the second carrier or cell (e.g., a target cell). For example, the first carrier or cell may send radio resource control (RRC) signaling to the NB-IoT device that triggers the NB-IoT device to perform a reestablishment procedure with redirection to redirect the wireless connection to the second carrier or cell.

IoT generally refers to the myriad physical objects or “things” connected to the Internet, all collecting and exchanging data with other devices and systems over the Internet. IoT extends internet connectivity beyond typical computing devices (e.g., such as desktops, laptops, smartphones, tablets, etc.) to any range of traditionally “dumb” or non-internet-enabled physical devices and everyday objects. For example, IoT devices are nonstandard computing hardware (e.g., such as sensors, actuators, gadgets, appliances, machines, etc.) that are programmed for certain applications, can connect wirelessly to a network, and can transmit data. IoT devices may include or can be embedded into other mobile devices, industrial equipment, environmental sensors, medical devices, and more to enable those devices to communicate and interact over the internet and to be remotely monitored and controlled.

Just as there are many different IoT devices, there are many types of IoT applications based on their usage. For example, the IoT applications may include consumer IoT (e.g., for everyday use, such as with home appliances, voice assistance devices, light fixtures, etc.), commercial IoT (e.g., used in the healthcare and transportation industries, such as with smart pacemakers and monitoring systems), Internet of Military Things (IoMT) (e.g., used for the application of IoT technologies in the military field, such as with surveillance robots and human-wearable biometrics for combat), Industrial Internet of Things (IIoT) (e.g., used with industrial applications, such as in the manufacturing and energy sectors, including digital control systems, smart agriculture, and industrial big data), and infrastructure IoT (e.g., used for connectivity in smart cities, such as infrastructure sensors and management systems), among other types of IoT applications not expressly listed or described herein.

NB-IoT is a low-power wide-area network (LPWAN) radio technology developed for cellular network devices (e.g., user equipments (UEs)) and services and limits a bandwidth for communications to a single narrow-band (e.g., of 200 kilohertz (kHz)). NB-IoT may enable communication with “things” that require small amounts of data, over long periods, in hard to reach places, or a combination thereof. NB-IoT provides low power consumption, an extended range, deployment into existing cellular network architectures, network security, network reliability, and lower component costs. For example, NB-IoT may enable communications for many potential “connected things” (e.g., NB-IoT devices) that are located in remote or hard to reach areas and/or are located long distances from a next cellular network entity, such as monitoring meters and sensors located in remote rural areas and/or in shielded areas (e.g., deep within buildings or underground structures).

As an example deployment or use, NB-IoT has become a popular choice for NTNs, where network entities may include spaceborne (e.g., satellite) or airborne (e.g., airship, balloon, etc.) platforms or parts of such a platform. In NTNs, the spaceborne or airborne network entities may travel across the sky or outer space (e.g., in orbit around the Earth, in flight paths at high altitudes, etc.) and provide communication coverage areas (e.g., cells) on the surface of the Earth that move along with the network entity. Thus, the spaceborne or airborne network entities may provide communications and coverage to remote or hard to reach areas. However, based on the high cell mobility of these spaceborne or airborne network entities, the coverage areas or cells corresponding to the network entities may move away from NB-IoT devices on the ground as the network entities travel across the sky or outer space, such that communications for the NB-IoT devices need to be redirected to a different network entity and/or cell. While described with reference to an NTN, other wireless communications systems not expressly listed herein may also include high cell mobility, such as high speed trains. Additionally or alternatively, NB-IoT devices may have high mobility, such as a sensor and/or identification tag that is attached to a vehicle (e.g., a delivery truck), which can be monitored by spaceborne or airborne network entities of an NTN.

Technical problems for redirecting communications for an NB-IoT device (e.g., an NB-IoT user equipment (UE)) include, for example, NB-IoT devices not supporting handover to redirect communications from a first cell to a second cell. As described previously, some wireless communications systems (e.g., NTNs) may include high cell mobility (e.g., cells or coverage areas for network entities move frequently or are in constant motion), such that a coverage area or cell for communications for a device moves away from the device, thereby resulting in a loss of coverage or communications for the device if the communications are not switched to a new cell. Additionally or alternatively, it may be beneficial to balance loads across multiple cells and/or network entities (e.g., to reduce over-burdening a single cell or network entity) by moving communications for one or more devices to other cells and/or network entities. Additionally or alternatively, a device may identify that a different cell and/or network entity (e.g., a target cell) has better communication conditions (e.g., lower interference, higher signal power, higher received power measurements, etc.) than a current cell and/or network entity (e.g., a serving cell), and it may provide more efficient communications by redirecting the communications for the device to the different cell and/or network.

However, in an NB-IoT network, the technical problem of NB-IoT devices not supporting handover may prevent the NB-IoT devices from redirecting communications to new cells and/or network entities. Therefore, the network may be unable to directly move an NB-IoT device to a different cell or carrier without knowing the coverage or communication conditions of the different cell or carrier. In some cases, the NB-IoT device can perform a reestablishment procedure to move communications to the new cell and/or network entity because the reestablishment procedure may include the NB-IoT device performing a cell selection procedure to select the new cell and/or network entity, but the reestablishment procedure may also include the NB-IoT device losing pending uplink and/or downlink data to or from the previous cell and/or network entity. As such, based on losing the pending data, the NB-IoT device may potentially increase latency and/or decrease reliability for communications for the NB-IoT device.

As described herein, a technical solution (e.g., techniques and signaling) is provided to overcome the aforementioned technical problem(s). For example, the technical solution may include signaling for performing a reestablishment procedure with redirection for an NB-IoT device. In some embodiments, after a network entity determines for an NB-IoT device to redirect communications from a first cell to a second cell (e.g., based on a load balancing demand, a coverage area for the first cell moving away from the NB-IoT device, assistance information from the NB-IoT device, etc.), the network entity may send, via the first cell, an RRC message that includes an indication for the NB-IoT device to redirect communications to the second cell. For example, a serving cell (e.g., the first cell) may send an RRC release message to the NB-IoT device and may direct the NB-IoT device to reestablish an RRC connection with a target cell (e.g., the second cell). Additionally or alternatively, the serving cell may send an RRC reestablishment message to the NB-IoT device and redirect the NB-IoT device to the target cell.

The techniques for performing a reestablishment procedure with redirection for an NB-IoT device as described herein may provide any of various beneficial effects and/or advantages. The technical effects of performing the reestablishment procedure with redirection for an NB-IoT device may include decreasing latency for communications based on the NB-IoT device preserving any pending uplink and/or downlink data using the redirection and not losing the pending uplink and/or downlink data during the reestablishment procedure, which may have resulted in retransmissions for the NB-IoT device to reacquire the pending downlink data and/or for the NB-IoT device to send the pending uplink data again. Additionally, the technical effects of performing the reestablishment procedure with redirection for the NB-IoT device may include increasing reliability of communications for the NB-IoT device based on the NB-IoT device not losing the pending uplink and/or downlink data while performing the reestablishment procedure. In some embodiments, the technical effects may also include less battery consumption and an increased battery life for the NB-IoT device based on the NB-IoT device not losing the pending uplink and/or downlink data while performing the reestablishment procedure, which may have otherwise caused the NB-IoT device to expend battery power to prepare the pending uplink data for transmission again and/or to receive the pending downlink data again.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

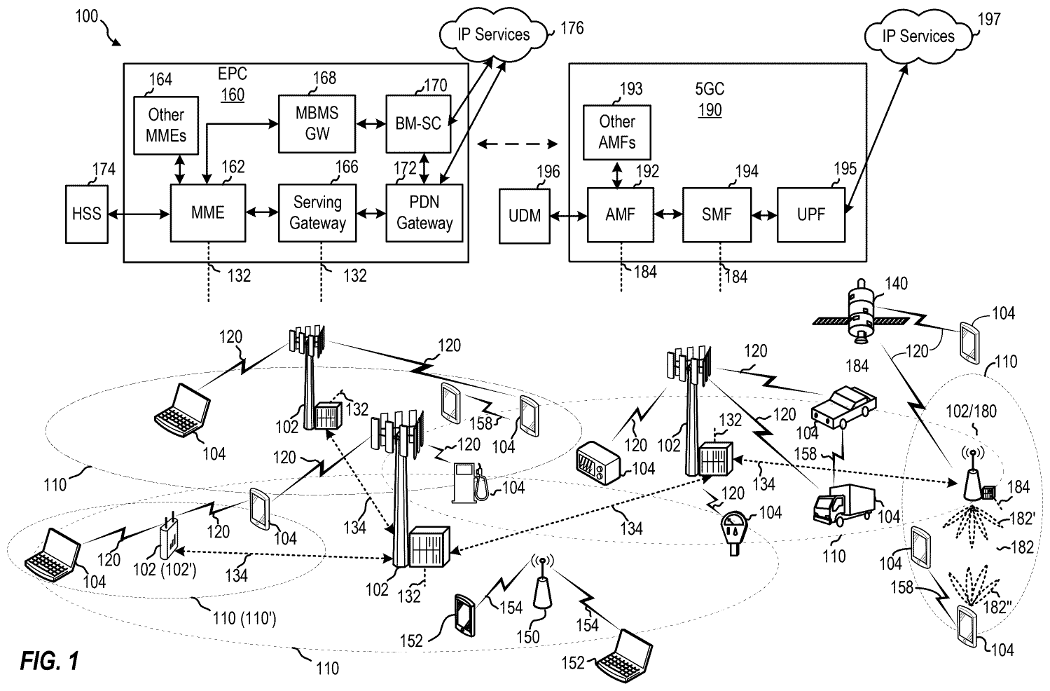

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

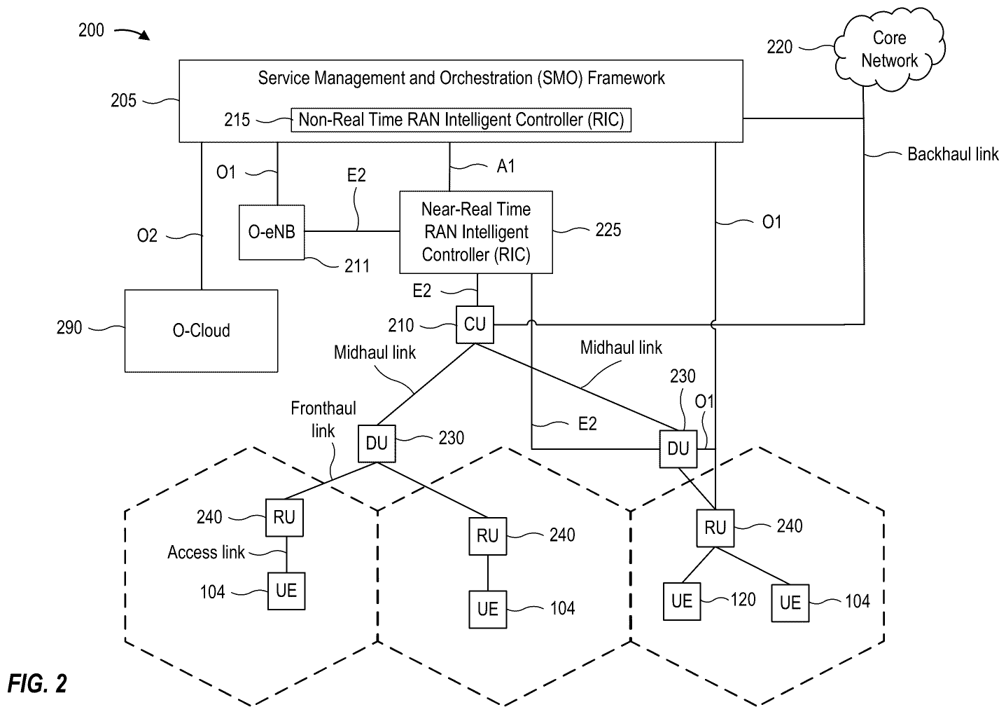

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

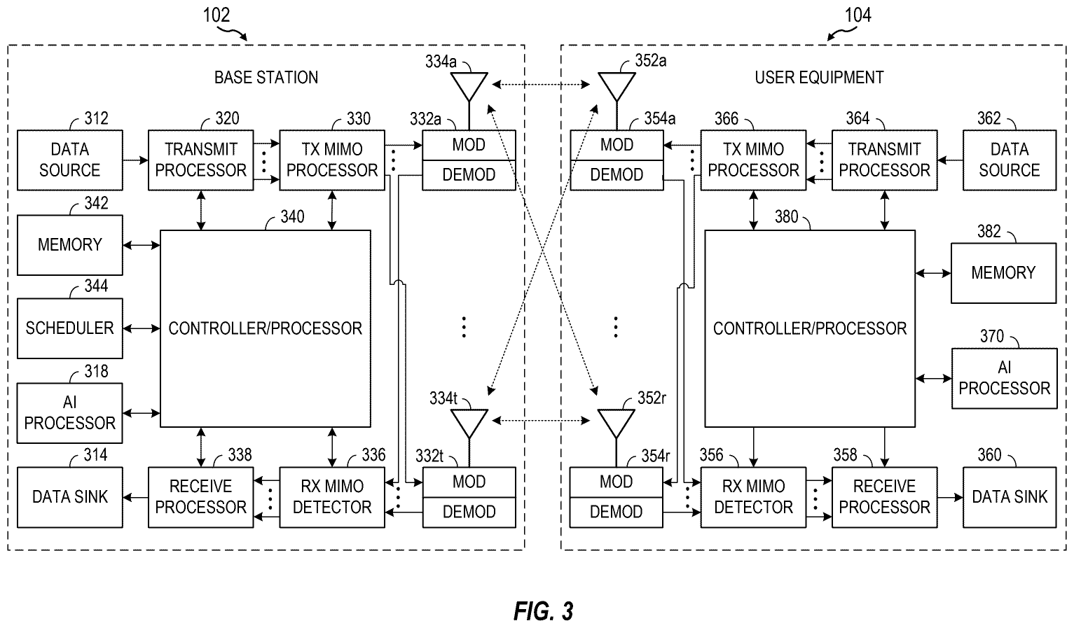

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or Al training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

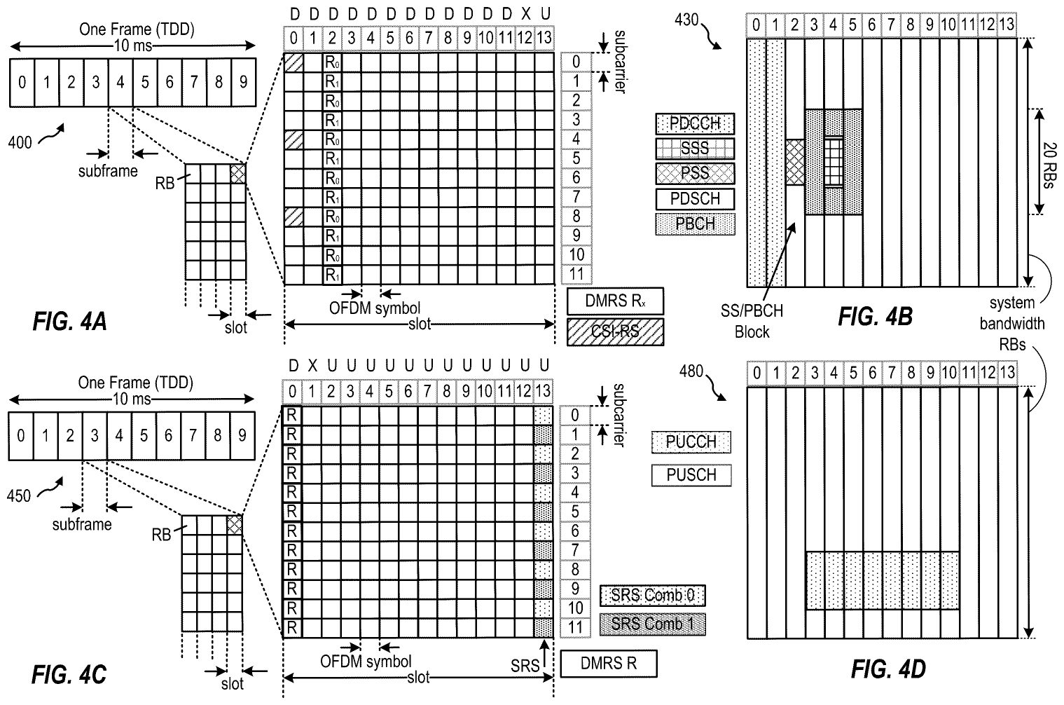

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 24 slots per subframe. Thus, numerologics (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 us.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Non-Terrestrial Network Communications

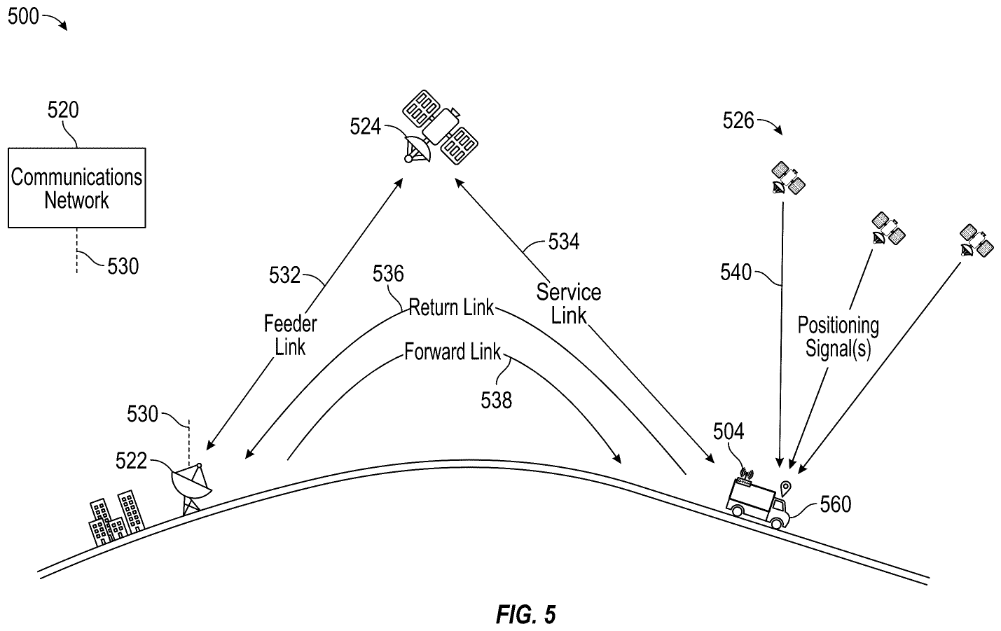

FIG. 5 depicts an example NTN 500. Certain wireless communication systems (e.g., Evolved Universal Terrestrial Radio Access (E-UTRA) systems, 5G New Radio (NR) systems, and/or future wireless communication systems) may facilitate communications coverage via an NTN, such as a spaceborne (e.g., satellite) or airborne (e.g., airship, balloon, etc.) platform that provides wireless connectivity to certain devices, such as UEs. In some cases, NTN communications may further facilitate communications with NB-IoT devices, such as a sensor and/or identification tag attached to a vehicle (e.g., a delivery truck).

In this example, the NTN 500 includes a communications network 520 (e.g., the EPC 160 and/or the 5GC network 190 of FIG. 1), an NTN gateway 522, and an NTN payload 524. The NTN 500 may facilitate wireless communications with one or more UEs 504 (e.g., the UE 104 of FIG. 1). The UE 504 may include any of various types of UEs, such as an NB-IoT UE. As an example, the UE 504 may include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that the NB-IoT UE is an example, and other UEs may be capable of NTN communications.

The NTN gateway 522 may communicate with the communications network 520 via one or more interfaces 530, such as backhaul links including NG interface(s) and/or S1 interface(s) between a RAN and a core network. The interface(s) 530 may include wired and/or wireless connections. The NTN gateway 522 may serve one or more NTN payloads 524 (e.g., network entities or NTN entities).

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous orbits (GSO) (e.g., Geostationary Earth Orbit (GEO)), Non-Geosynchronous Orbit (NGSO), which includes Low-Earth Orbit (LEO) and Medium Earth Orbit (MEO), or High Altitude Platform Systems (HAPS).

The NTN payload 524 may transparently forward communications (e.g., the radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link).

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain the location of the NTN payload 524 via system information from the NTN payload 524. The UE 504 may estimate a timing delay and Doppler effects associated with the service link 534 using the positioning signal(s) 540 and the location of the NTN payload 524.

Technical problems for NTN communications include, for example, high cell mobility for NTN payloads (e.g., satellites continually in motion orbiting the Earth, airborne platforms in flight patterns at high altitudes, etc.), which may necessitate redirecting service or communications for devices (e.g., the UE 504) from a first NTN payload (e.g., a serving cell, a first cell, a first network entity, a first satellite, etc.) to a second NTN payload (e.g., a target cell, a second cell, a second network entity, a second satellite, etc.). For example, devices may be stationary, moving at a slower speed than the NTN payloads, or moving in a direction away from a coverage area or cell of a current NTN payload, such that the high cell mobility of the NTN payloads results in the need to move service or communications for the devices from one NTN payload to another. Additionally, in some embodiments, further technical problems may arise, for example, for devices that are unable to perform or do not support handover, such as NB-IoT devices, when there is the need to move the service or communications for the devices from one NTN payload to another. For example, the devices may lose pending uplink and/or downlink data when service or communications are moved from one NTN payload to another based on the devices not supporting handover.

Aspects Related to a Reestablishment Procedure with Redirection for NB-IoT

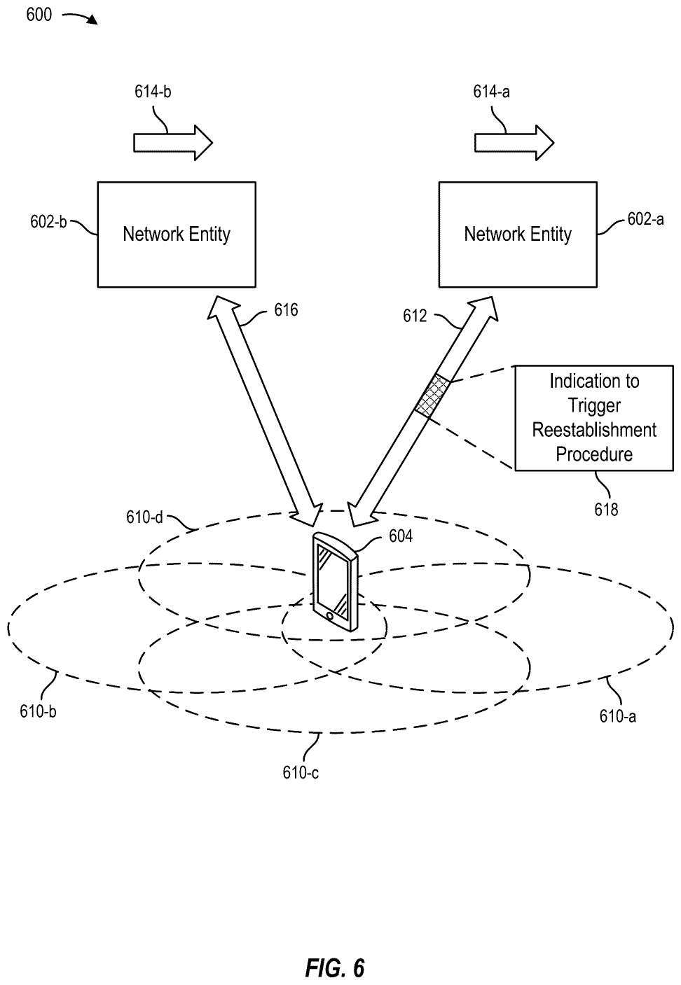

FIG. 6 depicts an example wireless communications network 600 that supports performing a reestablishment procedure with redirection for an NB-IoT device in accordance with aspects of the present disclosure. In some examples, the wireless communications network 600 may implement aspects of or may be implemented by aspects of FIGS. 1-5. For example, the wireless communications network 600 may include a first network entity 602-a, a second network entity 602-b, and at least one UE 604, where the network entities 602 represent base stations or similar network entities as described with reference to FIGS. 1-3 and 5 (e.g., BS 102, BS 180, satellite 140, NTN payload 524, etc.) and the UE 604 represents a UE or similar terminal device as described with reference to FIGS. 1-3 and 5 (e.g., UE 104, UE 504, etc.).

Additionally, the wireless communications network 600 may support communication between the network entities 602 and the UE 604. For example, the network entities 602 may provide communications coverage for one or more cells 610 (e.g., coverage areas 110 or cells as described with reference to FIG. 1) that include the UE 604.

The network entities 602 and the UE 604 may wirelessly communicate via communication links (e.g., one or more carriers, a communication link 120, beamforming 182, etc.). For example, the first network entity 602-a, and the UE 604 may communicate via a communication link 612, and the second network entity 602-b and the UE 604 may communicate via a communication link 616.

In some embodiments, the wireless communications network 600 may represent an NB-IoT network or system, and the UE 604 may represent an NB-IoT device. For example, the UE 604 may represent a device that is operating in and/or configured to operate in a control plane IoT optimization mode. Additionally, in some embodiments, the wireless communications network 600 may represent an NTN (e.g., as described with reference to FIG. 5), and the first network entity 602-a and/or the second network entity 602-b may represent spaceborne or airborne platforms (e.g., NTN payloads, satellites, aircraft, etc.).

NB-IoT is a good choice for NTN as previously described. However, NB-IoT devices (e.g., NB-IoT UEs, such as the UE 604) cannot be moved to another anchor carrier or cell (e.g., for load balancing purposes, to maintain communication connectivity for the NB-IoT devices as cells move away from the NB-IoT devices, etc.) as the NB-IoT devices may not support handover. In some cases, NB-IoT can operate in a multi-carrier mode (e.g., communications occur over multiple carriers or different frequency bandwidths), where a carrier for an initial connection setup is referred to as the anchor carrier and any additional carriers used for communications are referred to as non-anchor carriers.

In other types of communication networks (e.g., enhanced machine-type communication (eMTC)), to support redirecting communications for devices from a first cell to a second cell (e.g., for handover), network entities can provide system information of one or more cells for a redirected inter-radio access technology (RAT) carrier frequency but not on a same E-UTRA RAT frequency. However, for NB-IoT, network entities may be limited to provide carrier frequency, carrier-offset, and timer information to NB-IoT devices.

Based on previously-developed signaling and techniques, it may not be possible to move an NB-IoT device to a target cell without handover as the procedure provided in the example of FIG. 6. For example, the UE 604 may initially communicate with the first network entity 602-a (e.g., using the communication link 612) via a first cell 610-a, but the first network entity 602-a may be moving away from the UE 604 based on a movement 614-a for the first network entity 602-a (e.g., an orbit around the Earth, a flight path at high altitudes, etc.) such that it may become necessary to redirect the communications to a different cell and/or network entity to maintain communication services for the UE 604. In some embodiments, the second network entity 602-b may also be moving but moving towards the UE 604 based on a movement 614-b. Accordingly, it may be efficient to redirect the communications for the UE 604 to a cell served by the second network entity 602-b, such as a second cell 610-b, a third cell 610-c, or a fourth cell 610-d.

However, as described previously, NB-IoT devices, such as the UE 604, may not support handover. Additionally, NB-IoT devices may not support measurement reports (e.g., sending measurement reports of signal quality or signal strength for one or more nearby cells), such that the network (e.g., the first network device 602-a) cannot directly move an NB-IoT device or UE to a different cell or carrier based on not knowing the coverage or communication conditions of other nearby cells.

In some cases, the NB-IoT device can perform a reestablishment procedure to move communications to a different cell based on the reestablishment procedure including the NB-IoT first performing a cell selection procedure. Based on performing the cell selection procedure, the NB-IoT device may find a cell with better communication conditions (e.g., lower interference, higher signal quality, higher signal power, etc.) and go to that cell (e.g., reestablish communications with that cell). However, previously-developed reestablishment procedures may also include the NB-IoT dropping any pending UL and/or DL data before reestablishing communications and performing the cell selection procedure (e.g., the current communications with a current cell are dropped prior to reestablishing the communications with a different cell). Two types of reestablishment procedures may exist for NB-IoT devices to reestablish communications with a new or target cell: a reestablishment procedure with security enabled (e.g., performed between the NB-IoT devices and the network entities) and a reestablishment procedure without security enabled (e.g., performed by the core network).

Additionally, in NTN, the movements of network entities may be predictable. For example, the movement 614-a for the first network entity 602-a and the movement 614-b for the second network entity 602-b may be known or predictable, such as static orbits around the Earth or configured flight paths at high altitudes (e.g., the flight paths may be characterized by ephemeris data shared and/or known within the network). As such, a target cell for a reestablishment procedure (e.g., a cell to which communications for the NB-IoT device is to be or can be reestablished) can be predictable.

As described herein, techniques and signaling are provided to enable an NB-IoT device to be moved to a target cell (e.g., a new cell or new anchor carrier or new satellite) without handover and without a release procedure. For example, the techniques and signaling may include the NB-IoT device using a reestablishment procedure with redirection to move communications to the target cell. Using the reestablishment procedure with redirection may enable the NB-IoT device to move to a new cell without losing pending UL and/or DL data and without performing a handover.

In some embodiments and in the example of the wireless communications network 600, a network triggered RRC-reestablishment procedure may be performed by the UE 604 to redirect communications (e.g., on the communication link 612) with the first network entity 602-a via the first cell 610-a to the second network entity 602-b (e.g., on the communication link 616) via a different cell (e.g., the second cell 610-b, the third cell 610-c, or the fourth cell 610-d). For example, the first network entity 602-a may determine the UE 604 is to redirect the communications from the first cell 610-a (e.g., source cell, initial anchor carrier, initial cell, etc.) to the different cell (e.g., target cell, new anchor carrier, new cell, etc.). In some embodiments, the first network entity 602-a may determine to redirect the UE 604 is to or needs to redirect communications based on a load balancing demand, identifying a coverage area for the first cell 610-a is moving away from the UE 604, receiving assistance information from the UE 604, or a combination thereof.

Subsequently, after determining that the UE 604 is to redirect the communications to a different cell, the first network entity 602-a may send an indication 618 for the UE 604 to redirect the communications from the first cell 610-a to a different cell. Accordingly, after receiving the indication 618, the UE 604 may perform a reestablishment procedure to redirect the communications to the different cell. As described herein, the first network entity 602-a may send the indication 618 in an RRC message.

In some embodiments, the first network entity 602-a may send an RRC release message (e.g., RRCConnectionRelease-NB message) that includes the indication 618 for the UE 604 to trigger the reestablishment procedure. For example, the indication 618 may include an information element (IE) in the RRC release message that triggers the UE 604 to perform the reestablishment procedure and redirect the communications from the first cell 610-a to a different cell. In some embodiments, the IE may be an RRC-Reestablishment with redirection indication (e.g., ReestablishmentWithRedirect IE).

The IE may include cell information (e.g., carrier frequency, cell identifier (ID), satellite information, etc.) of one or more cells to which the communications can be redirected (e.g., target cells). Additionally, the IE may include the MIB and one or more SIBs (e.g., SIB1 and SIB19) for the one or more cells. In some embodiments, the IE may include cell information for multiple cells, and the UE 604 may select which cell to redirect the communications from the multiple cells. For example, the UE 604 may use existing dedicated carrier offset and timer information to select the target cell for redirecting the communications. Additionally or alternatively, a threshold can be defined for the UE 604 as criteria to select the target cell. In some embodiments, the IE may include cell information for a single cell for the UE 604 to redirect the communications to the single cell.

In some embodiments, after receiving the indication 618 to redirect communications, the UE 604 may trigger a radio link failure (RLF) and perform the reestablishment procedure to redirect the communications to the target cell with a reestablishment cause (e.g., ReestablishmentCause-NB IE or message) that indicates or includes a “Redirect” value. For example, if the indication 618 is included in an RRC release message as described previously, the UE 604 may not follow a corresponding release procedure and, instead, may trigger the RLF. Subsequently, as part of the triggered RLF, the UE 604 may send an RRC reestablishment request message to the target cell for continuing the communications on the target cell.

In the RRC reestablishment request message, the UE 604 may indicate a cause value to let the target cell know why the UE 604 is sending the RRC reestablishment request message to the target cell. For example, the cause value may indicate or include a “Redirect” value in the reestablishment cause in the RRC reestablishment request message. In some embodiments, a spare value in the reestablishment cause can be used to indicate or include the “Redirect” value. Additionally or alternatively, a spare value in the RRC reestablishment request message can be used to indicate or include the “Redirect” value. Additionally or alternatively, a new logical channel ID (LCID) code point for the logical channels can be used to indicate or include the “Redirect” value.

For NB-IoT, when Access Stratum (AS) security is not enabled, an RRC reconfiguration or UE information request message cannot be used for the indication 618 or to trigger the UE 604 to redirect the communications. In some embodiments, the first network entity 602-a may use or send a MAC control element (CE) command or DCI to redirect the communications for the UE 604.

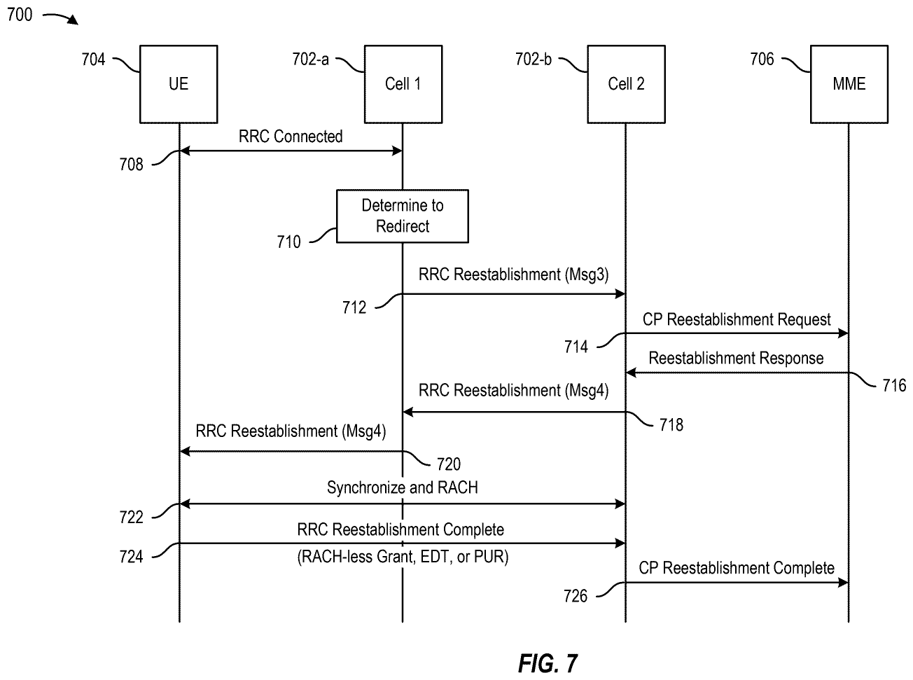

In some embodiments, alternative to using an RRC release message for the indication 618, the first network entity 602-a may use an RRC reestablishment message (e.g., RRCConnectionReestablishment-NB message) with redirection for the indication 618. In such embodiments, if the reestablishment with redirection configuration is present, the UE 604 may ignore other information in the RRC reestablishment message (e.g., a nextHopChainingCount IE). For integrity protection, the first network entity 602-a may include a DL Non-Access Stratum (NAS) MAC IE (e.g., dl-NAS-MAC IE) in the RRC reestablishment message. For example, the DL NAS MAC IE may include an NAS integrity protection parameter. Additionally, the first network entity 602-a may include a dedicated radio resource configuration (e.g., radioResourceConfigDedicated IE) in the RRC reestablishment message that corresponds to the target cell to which the UE 604 is to redirect the communications. Using the RRC reestablishment message for the indication 618 is described in greater detail with reference to FIG. 7.

In some embodiments, the network may configure the UE 604 on whether to follow an existing barring check to select the target cell or not (e.g., whether the UE 604 is barred from accessing one or more cells or not). For example, a barring check may include a device checking whether the device is barred from accessing and/or communicating with a cell based on broadcasted information from the cell (e.g., a barring factor). If configured to ignore the barring check or a default assumption is to ignore the barring check, the UE 604 may not check access barring. Additionally, if configured to ignore the barring check or a default assumption is to ignore the barring check, the UE 604 may ignore a cell barring indication in a SIB for the target cell (e.g., SIB1 for NTN) and also may not need to acquire an additional SIB for the target cell (e.g., SIB14) even if a MIB for the target cell indicates the UE 604 needs to check cell barring.

In some embodiments, the UE 604 may redirect the communications to a dedicated redirected cell. For example, similar to a secondary cell (SCell), the network may define a dedicated redirected cell. In some embodiments, the dedicated redirected cell may be a mobile cell (e.g., satellite), a stationary cell (e.g., a terrestrial base station), a LEO cell, a GEO cell, or a different type of cell not explicitly listed herein. Additionally, the dedicated redirected cell may be defined as a “connected mode ONLY cell”. The dedicated redirected cell may enable or include a barring bit, such that no other UEs can camp on the cell (e.g., remain connected to the cell for an extended period of time to monitor for signals from the cell but not necessarily send any signaling to the cell). Additionally, the dedicated redirected cell may not broadcast any system information except one or more SIBs (e.g., SIB1, SIB2, SIB31) to bar UEs from accessing the cell. Before redirecting to the dedicated redirected cell, the first network entity 602-a may provide all necessary information for the dedicated redirected cell to the UE 604. In some embodiments, the dedicated redirected cell may not support paging (e.g., as eMTC and NB-IoT UEs do not check paging and system information when in an RRC connected mode), which may provide resource savings for the network.

NB-IoT may support connected mode measurements for NB-IoT devices (e.g., the UE 604). Additionally, NB-IoT devices may use time and location-based criteria to trigger the measurements. However, these measurements are not conventionally reported to the network. In some cases, the NB-IoT devices may use the measurements to identify a target cell more quickly in case of RLF.

In some embodiments, the UE 604 may provide UE assistance information to the first network entity 602-a to assist in redirecting the communications from the first cell 610-a to a different cell. For example, the UE 604 may use an UL transfer information message or an UL dedicated control channel (DCCH) message or an UL MAC-CE to indicate an ordered list (e.g., a ranked list) of neighbor cells the UE measured. The network may then use this information to prepare the cell target for redirection with reestablishment for the communications for the UE 604. As there may not be AS security enabled or established between the UE 604 and the first network entity 602-a, the UE 604 may not report other information for the neighboring cells (e.g., such as measured reference signal received power (RSRP)). In some embodiments, the UE 604 may provide the UE assistance information in response to receiving the indication 618 to redirect the communications. Additionally or alternatively, the UE 604 may provide the UE assistance information periodically.

It is to be understood that while the aforementioned described techniques and signaling are described in reference to an NTN, the reestablishment procedure with redirection may be performed for an NB-IoT device in communications networks other than NTNs. For example, while it may be needed to move communication or service for an NB-IoT device from a first cell to a second cell in an NTN based on the high cell mobility of network entities in the NTN (e.g., satellites), the NB-IoT device may perform the reestablishment procedure with redirection to redirect communications from a first cell to a second cell for other purposes, such as load balancing, the second cell having better communication conditions for the NB-IoT device, the NB-IoT device moving into a coverage area corresponding to the second cell, etc. that are not specific to NTNs. Additionally, it is to be understood that other types of devices than NB-IoT devices may employ the techniques and signaling described herein to perform the reestablishment procedure with redirection.

Additionally, while the example of FIG. 6 illustrates redirecting the communications for the UE 604 from the first network entity 602-a to the second network entity 602-b, the UE 604 may perform the reestablishment procedure to redirect the communications from a serving cell (e.g., first cell) to a target cell (e.g., second cell) that are served by a same network entity 602. For example, the first network entity 602-a may provide communications for devices in the first cell 610-a and the third cell 610-c. However, if the number of devices served by the first network entity 602-a via the first cell 610-a becomes too high, the first network entity 602-a may redirect communications for one or more devices (e.g., the UE 604) or trigger the one or more devices to redirect communications to the third cell 610-c (e.g., for load balancing).

Example Operations for Reestablishment with Redirection

FIG. 7 depicts a process flow 700 that supports performing a reestablishment procedure with redirection for an NB-IoT device in accordance with aspects of the present disclosure. For example, the process flow 700 may support communications in a network between one or more network entities and an NB-IoT device, where the one or more network entities represent a base station, cell served by a network entity, or similar network entity as described with reference to FIGS. 1-3 and 5-6 (e.g., BS 102, BS 180, satellite 140, NTN payload 524, network entity 602-a, network entity 602-b, etc.) and the NB-IoT device represents a UE or similar terminal device as described with reference to FIGS. 1-3 and 5-6 (e.g., UE 104, UE 504, UE 604, etc.). For example, the NB-IoT device may be a device that is operating in and/or is configured to operate in a control plane IoT optimization mode. The one or more network entities may include or may be represented by a first cell 702-a (e.g., served by a first network entity, such as the first network entity 602-a as described with reference to FIG. 6), a second cell 702-b (e.g., served by the first network entity or a second network entity, such as the second network entity 602-b as described with reference to FIG. 6), and an MME 706 (e.g., MME 162 or other MMEs 164 as described with reference to FIG. 1), and the NB-IoT device may include a UE 704.

In the following description of the process flow 700, the operations between the UE 704, the first cell 702-a, the second cell 702-b, and the MME 706 may be performed in different orders or at different times. Certain operations may also be left out of the process flow 700, or other operations may be added to the process flow 700. It is to be understood that while the UE 704, the first cell 702-a, the second cell 702-b, and the MME 706 are shown performing a number of the operations of the process flow 700, any wireless device may perform the operations shown.

At 708, the UE 704 and the first cell 702-a may be in an RRC connected mode for communicating with each other. At 710, the first cell 702-a may determine to redirect the communications for the UE 704 to the second cell 702-b and/or to trigger the UE 704 to redirect the communications to the second cell 702-b. For example, the first cell 702-a may trigger the UE 704 to redirect the communications to the second cell 702-b based on a load balancing demand, identifying a coverage area for the first cell 702-a is moving away from the UE 704, receiving assistance information from the UE 704, or a combination thereof.

At 712, the first cell 702-a may send an RRC reestablishment message (e.g., Msg3) to the second cell 702-b based on the determination. In some embodiments, the RRC reestablishment message may indicate to the second cell 702-b that the first cell 702-a is going to trigger the UE 704 to redirect the communications to the second cell 702-b. Additionally, in some embodiments, the first cell 702-a may send an NAS integrity protection parameter with the RRC reestablishment message. For example, the NAS integrity protection parameter may include a downlink NAS MAC parameter or message.

At 714, the second cell 702-b may send a control plane (CP) reestablishment request to the MME 706 based on receiving the RRC reestablishment message from the first cell 702-a. For example, the CP reestablishment request may include a request to reestablish and redirect the communications for the UE 704 to the second cell 702-b.

At 716, the MME 706 may send a reestablishment response to the second cell 702-b based on the CP reestablishment request. For example, the reestablishment response may include an indication for the UE 704, the first cell 702-a, and the second cell 702-b to proceed with redirecting the communications for the UE 704 from the first cell 702-a to the second cell 702-b.

At 718, the second cell 702-b may send an RRC reestablishment message (e.g., Msg4) to the first cell 702-a based on receiving the reestablishment response from the MME 706.

At 720, the first cell 702-a may send an RRC reestablishment message (e.g., Msg4) with redirection to the UE 704. For example, the RRC reestablishment message may include an indication configured to trigger the UE 704 to perform a reestablishment procedure to redirect the communications to the second cell 702-b. In some embodiments, the RRC reestablishment message may represent the indication 618 to redirect communications as described with reference to FIG. 6.

At 722, the UE 704 may synchronize and perform a random access channel (RACH) procedure to establish a connection for communications with the second cell 702-b. Additionally, the UE 704 may apply any configurations for the second cell 702-b to establish the connection for the communications with the second cell 702-b.

At 724, after switching to the second cell 702-b (e.g., the target cell) and applying a configuration for the second cell 702-b, the UE 704 may send an RRC reestablishment complete message (e.g., RRCConnectionReestablishmentComplete-NB in Msg3) to the second cell 702-b. In some embodiments, the UE 704 may send the RRC reestablishment complete message using a RACH-less grant, early data transmission (EDT), a preconfigured uplink resource (PUR), or a combination thereof. For example, the UE 704 may be provided with a contention free preamble for the second cell 702-b and a dedicated PRACH resource for sending the RRC reestablishment complete message. In some embodiments, the UE may also include a corresponding UL NAS MAC IE (e.g., ul-NAS-MAC IE) and UL NAS Count IE (e.g., ul-NAS-Count IE) in the RRC reestablishment complete message for integrity protection. For example, the UL NAS MAC IE may be a response to the NAS integrity protection parameter sent by the first cell 702-a with the RRC reestablishment message at 712.

At 726, the second cell 702-b may send a CP reestablishment complete message to the MME 706 to indicate the communications for the UE 704 have been successfully reestablished and redirected to the second cell 702-b.

### Example Operations of Entities in a Communications Network

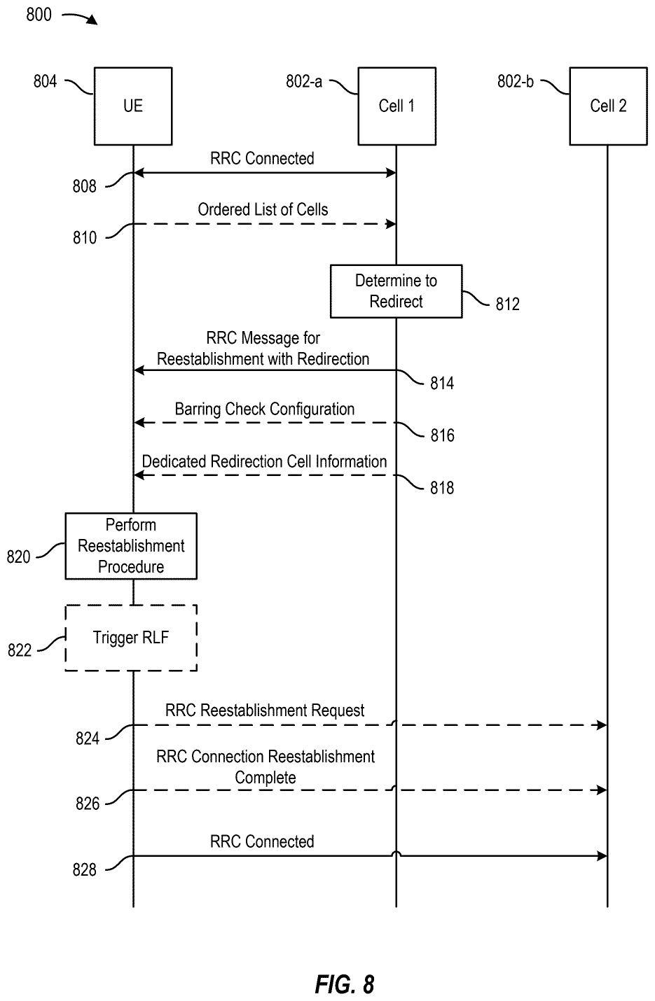

FIG. 8 depicts a process flow 800 that supports performing a reestablishment procedure with redirection for an NB-IoT device in accordance with aspects of the present disclosure. For example, the process flow 800 may support communications in a network between one or more network entities and an NB-IoT device, where the one or more network entities represent a base station, cell served by a network entity, or similar network entity as described with reference to FIGS. 1-3 and 5-7 (e.g., BS 102, BS 180, satellite 140, NTN payload 524, network entity 602-a, network entity 602-b, etc.) and the NB-IoT device represents a UE or similar terminal device as described with reference to FIGS. 1-3 and 5-7 (e.g., UE 104, UE 504, UE 604, etc.). For example, the NB-IoT device may be a device that is operating in and/or is configured to operate in a control plane IoT optimization mode. The one or more network entities may include or may be represented by a first cell 802-a (e.g., served by a first network entity, such as the network first entity 602-a as described with reference to FIG. 6), a second cell 802-b (e.g., served by the first network entity or a second network entity, such as the second network entity 602-b as described with reference to FIG. 6), and the NB-IoT device may include a UE 804.

In the following description of the process flow 800, the operations between the UE 804, the first cell 802-a, and the second cell 802-b may be performed in different orders or at different times. Certain operations may also be left out of the process flow 800, or other operations may be added to the process flow 800. It is to be understood that while the UE 804, the first cell 802-a, and the second cell 802-b are shown performing a number of the operations of the process flow 800, any wireless device may perform the operations shown.

At 808, the UE 804 and the first cell 802-a are in an RRC connected mode for communicating with each other.

At 810, the UE 804 may send, to the first cell 802-a, an ordered list of one or more cells neighboring the first cell 802-a. For example, the one or more cells neighboring the first cell 802-a may be ordered based on measurements made by the UE 804 on the one or more cells (e.g., the ordered list is a ranked list of the one or more cells). In some embodiments, the UE 804 may send the ordered list of the one or more cells neighboring the first cell 802-a to the first cell 802-a via an uplink transfer information message, an uplink DCCH message, or an uplink MAC-CE. In some embodiments, the UE 804 may send the ordered list of the one or more cells neighboring the first cell 802-a periodically.

At 812, the first cell 802-a determines to redirect the communications for the UE 804 to the second cell 802-b and/or to trigger the UE 804 to redirect the communications to the second cell 802-b. For example, the first cell 802-a may trigger the UE 804 to redirect the communications to the second cell 802-b based on a load balancing demand, identifying a coverage area for the first cell 802-a is moving away from the UE 804, receiving assistance information from the UE 804 (e.g., the ordered list of the one or more cells neighboring the first cell 802-a), or a combination thereof. Additionally, in some embodiments, the first cell 802-a may prepare the second cell 802-b for the redirection of the communications for the UE 804 based on the determination and the ordered list received at 810.

At 814, the UE 804 receives, via the first cell 802-a, an RRC message that includes an indication for the UE 804 to redirect communications that are occurring via the first cell 802-a to the second cell 802-b. For example, the indication may be configured to trigger the UE 804 to perform a reestablishment procedure to redirect the communications to the second cell. In some embodiments, the UE 804 may send the ordered list of the one or more cells neighboring the first cell 802-a in response to receiving the RRC message that includes the indication.

In some embodiments, the RRC message may include an RRC release message, and the RRC release message includes an IE used to indicate or trigger the UE 804 to redirect the communications to the second cell 802-b. In some embodiments, the IE may include a carrier frequency, a cell ID, satellite information, a MIB, one or more SIBs, or a combination thereof for each cell of one or more cells to which the communications can be redirected, and the UE 804 may select the second cell 802-b for redirecting the communications from the one or more cells indicated by the IE. For example, the UE 804 may select the second cell 802-b based on a dedicated carrier offset, timer information, a threshold value, or a combination thereof.

Additionally or alternatively, the RRC message may include an RRC reestablishment message, and the RRC reestablishment message may include an IE used to indicate or trigger the UE 804 to redirect the communications to the second cell 802-b. In some embodiments, the RRC reestablishment message is received and the reestablishment procedure is triggered based on AS not being enabled for the communications via the first cell 802-a, a threshold to select the second cell 802-b being satisfied, or a combination thereof. Additionally, the RRC reestablishment message may also include a DL NAS MAC IE and a dedicated radio resource configuration corresponding to the second cell 802-b. For example, the UE 804 may receive the RRC message comprising the indication to redirect the communications and an NAS integrity protection parameter.

At 816, the UE 804 may receive, via the first cell 802-a, a configuration to ignore an access barring check for the second cell 802-b. For example, the network may configure the UE 804 on whether to follow an existing barring check to select a target cell or not. In some embodiments, a default assumption may include the UE 804 being configured to ignore the barring check.

At 818, the UE 804 may receive, via the first cell 802-a, cell information for a dedicated redirection cell. For example, the dedicated redirection cell may be a dedicated cell for the UE 804 to perform the reestablishment procedure with redirection to redirect the communications. In the example of FIG. 8, the dedicated redirection cell may be the second cell 802-b.

At 820, the UE 804 performs the reestablishment procedure to redirect the communications to the second cell 802-b based on receiving the RRC message comprising the indication at 814. In some embodiments, the UE 804 may perform the he reestablishment procedure to redirect the communications to the second cell 802-b based on the dedicated radio resource configuration corresponding to the second cell 802-b (e.g., if the RRC message is the RRC reestablishment message), the configuration to ignore the access barring check for the second cell 802-b (e.g., received at 816), the cell information for the dedicated redirection cell (e.g., received at 818), the ordered list of the one or more cells neighboring the first cell 802-a (e.g., sent at 810), or a combination thereof.

At 822, the UE 804 may trigger an RLF procedure for the communications via the first cell 802-a based on receiving the RRC message comprising the indication to redirect the communications at 814. For example, the UE 804 may trigger the RLF procedure if the RRC message is the RRC release message, but rather than the UE 804 following a release procedure, the UE 804 triggers the RLF procedure.

At 824, the UE 804 may send, via the second cell 802-b, an RRC reestablishment request message based on triggering the RLF procedure. In some embodiments, the RRC reestablishment request message may include a redirect indication (e.g., a cause for the reestablishment procedure and why the UE 804 is sending the RRC reestablishment request message to the second cell 802-b), a reestablishment cause IE that includes the redirect indication, an LCID codepoint corresponding to the redirect indication, or a combination thereof. Additionally, in some embodiments, the UE 804 may send, via the second cell 802-b, the reestablishment request message based on receiving the RRC message comprising the indication to redirect the communications and the NAS integrity protection parameter, and the reestablishment request message may include a response to the NAS integrity protection parameter.

At 826, the UE 804 may send, via the second cell 802-b, an RRC connection reestablishment complete message based on performing the reestablishment procedure. In some embodiments, the UE 804 may send the RRC connection reestablishment complete message when the RRC message that includes the indication is an RRC reestablishment message (e.g., as described with reference to FIG. 7).

At 828, the UE 804 and the second cell 802-b are in an RRC connected mode for communicating with each other based on the UE 804 performing the reestablishment procedure to redirect the communications to the second cell 802-b.

Note that FIG. 8 is just one example of a process flow, and other process flows including fewer, additional, or alternative operations are possible consistent with this disclosure.

### Example Operations of a User Equipment

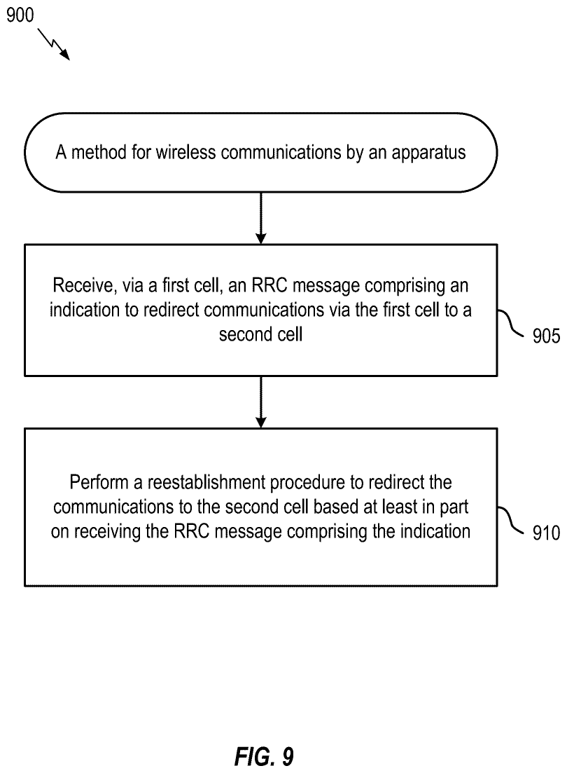

FIG. 9 shows a method 900 for wireless communications by an apparatus, such as UE 104 of FIGS. 1 and 3.

Method 900 begins at block 905 with receiving, via a first cell, an RRC message comprising an indication to redirect communications via the first cell to a second cell.

Method 900 then proceeds to block 910 with performing a reestablishment procedure to redirect the communications to the second cell based at least in part on receiving the RRC message comprising the indication.

In certain aspects, the RRC message comprises an RRC release message; and the RRC release message comprises an IE used to indicate redirection of the communications to the second cell.

In certain aspects, the IE comprises a carrier frequency, a cell identifier, satellite information, a MIB, one or more SIBs, or a combination thereof for each cell of one or more cells to which the communications can be redirected; and the method 900 further comprises selecting the second cell for redirecting the communications from the one or more cells indicated by the IE, the second cell selected based at least in part on a dedicated carrier offset, timer information, a threshold value, or a combination thereof.

In certain aspects, method 900 further includes triggering an RLF procedure for the communications via the first cell based at least in part on receiving the RRC message comprising the indication to redirect the communications.

In certain aspects, method 900 further includes sending, via the second cell, an RRC reestablishment request message based at least in part on triggering the RLF procedure.

In certain aspects, the RRC reestablishment request message comprises a redirect indication, a reestablishment cause IE comprising the redirect indication, an LCID codepoint corresponding to the redirect indication, or a combination thereof.

In certain aspects, the RRC message comprises an RRC reestablishment message; and the RRC reestablishment message comprises an IE used to indicate redirection of the communications to the second cell.

In certain aspects, method 900 further includes sending, via the second cell, an RRC connection reestablishment complete message based at least on performing the reestablishment procedure.

In certain aspects, the RRC reestablishment message is received and the reestablishment procedure is triggered based at least in part on AS not being enabled for the communications via the first cell, a threshold to select the second cell being satisfied, or a combination thereof.

In certain aspects, the RRC reestablishment message also comprises a downlink NAS MAC IE and a dedicated radio resource configuration corresponding to the second cell; and the reestablishment procedure is performed to redirect the communications to the second cell based at least in part on the dedicated radio resource configuration corresponding to the second cell.

In certain aspects, method 900 further includes receiving, via the first cell, a configuration to ignore an access barring check for the second cell.

In certain aspects, method 900 further includes performing the reestablishment procedure to redirect the communications to the second cell based at least in part on receiving the configuration.

In certain aspects, method 900 further includes receiving, via the first cell, cell information for a dedicated redirection cell.

In certain aspects, method 900 further includes performing the reestablishment procedure to redirect the communications to the second cell based at least in part on receiving the cell information for the dedicated redirection cell, wherein the second cell comprises the dedicated redirection cell.

In certain aspects, method 900 further includes sending, via the first cell, an ordered list of one or more cells neighboring the first cell, the one or more cells neighboring the first cell being ordered based at least in part on measurements performed on the one or more cells.

In certain aspects, method 900 further includes receiving the RRC message comprising the indication to redirect the communications based at least in part on sending the ordered list.

In certain aspects, the ordered list of the one or more cells neighboring the first cell is sent via an uplink transfer information message, an uplink DCCH message, or an uplink MAC-CE.

In certain aspects, the apparatus comprises a device operating in a control plane IoT optimization mode (e.g., an NB-IoT device).

In certain aspects, the method 900 further includes receiving the RRC message comprising the indication to redirect the communications and an NAS integrity protection parameter.

In certain aspects, the method 900 further includes sending, via the second cell, a reestablishment request message based at least in part on receiving the RRC message comprising the indication to redirect the communications and the NAS integrity protection parameter, wherein the reestablishment request message comprises a response to the NAS integrity protection parameter.

In certain aspects, method 900 may be performed by the apparatus to realize one or more technical effects or solutions to the aforementioned technical problem(s). For example, based on method 900, the apparatus may decrease latency for the communications by performing the reestablishment procedure to redirect the communications from the first cell to the second cell and, thus, preserving any pending uplink and/or downlink data, which may have otherwise resulted in retransmissions for the apparatus to reacquire the pending downlink data and/or for the apparatus to send the pending uplink data again. Additionally, based on method 900, the apparatus may increase reliability of the communications when performing the reestablishment procedure to redirect the communications from the first cell to the second cell based on not losing the pending uplink and/or downlink data while performing the reestablishment procedure.

Additionally, based on method 900, the apparatus may consume less battery power and increase battery life when performing the reestablishment procedure to redirect the communications from the first cell to the second cell based on not losing the pending uplink and/or downlink data while performing the reestablishment procedure, which may have otherwise caused the apparatus to expend battery power to prepare the pending uplink data for transmission again and/or to receive the pending downlink data again.

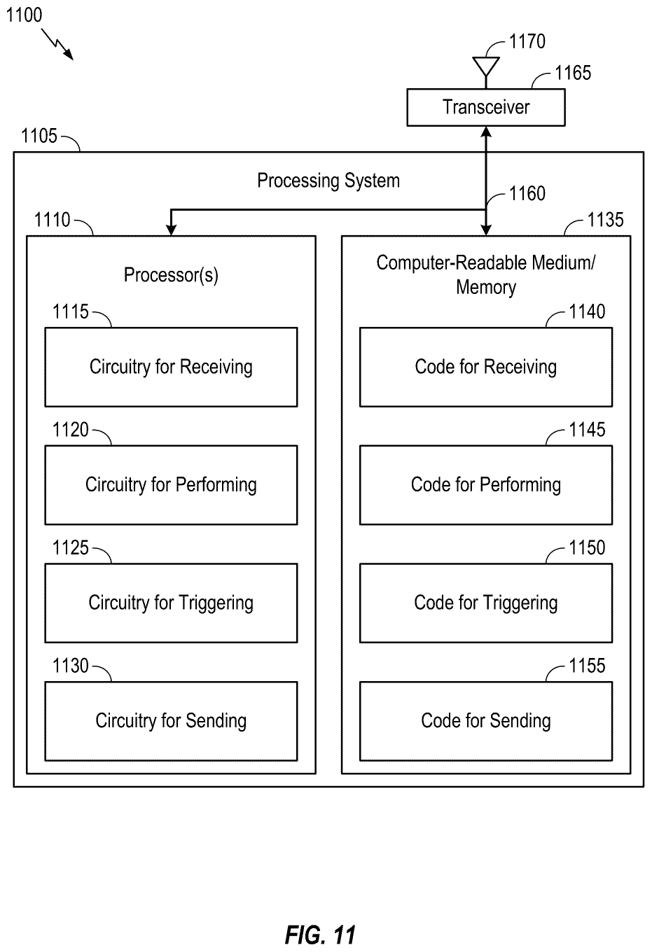

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a Network Entity

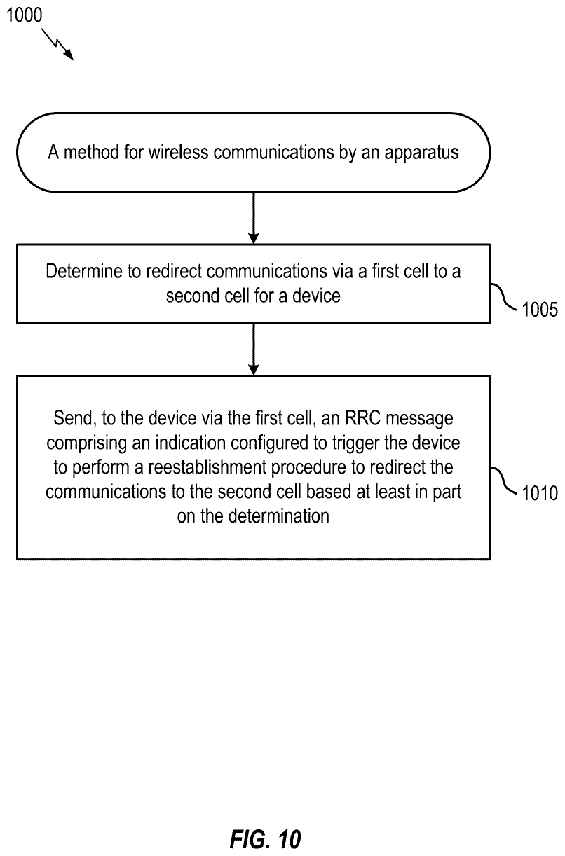

FIG. 10 shows a method 1000 for wireless communications by an apparatus, such as BS 102 of FIGS. 1 and 3, or a disaggregated base station as discussed with respect to FIG. 2.

Method 1000 begins at block 1005 with determining to redirect communications via a first cell to a second cell for a device.

Method 1000 then proceeds to block 1010 with sending, to the device via the first cell, an RRC message comprising an indication configured to trigger the device to perform a reestablishment procedure to redirect the communications to the second cell based at least in part on the determination.

In certain aspects, the RRC message comprises an RRC release message; and the RRC release message comprises an IE used to indicate redirection of the communications to the second cell.

In certain aspects, the IE comprises a carrier frequency, a cell identifier, satellite information, a MIB, one or more SIBs, or a combination thereof for each cell of one or more cells to which the communications can be redirected for the device.

In certain aspects, method 1000 further includes receiving, from the device via the second cell, an RRC reestablishment request message based at least in part on sending the RRC message comprising the indication via the first cell.

In certain aspects, the RRC reestablishment request message comprises a redirect indication, a reestablishment cause IE comprising the redirect indication, an LCID codepoint corresponding to the redirect indication, or a combination thereof.

In certain aspects, the RRC message comprises an RRC reestablishment message; and the RRC reestablishment message comprises an IE used to indicate redirection of the communications to the second cell.

In certain aspects, method 1000 further includes receiving, from the device via the second cell, an RRC connection reestablishment complete message based at least on the device performing the reestablishment procedure after the RRC reestablishment message comprising the IE is sent to the device.

In certain aspects, the RRC reestablishment message comprising the IE is sent to trigger the device to perform the reestablishment procedure based at least in part on AS not being enabled for the communications for the device via the first cell, a threshold to select the second cell being satisfied, or a combination thereof.

In certain aspects, the RRC reestablishment message also comprises a downlink NAS MAC IE and a dedicated radio resource configuration corresponding to the second cell; and the reestablishment procedure is configured to be performed by the device to redirect the communications to the second cell based at least in part on the dedicated radio resource configuration corresponding to the second cell.

In certain aspects, method 1000 further includes sending, to the device via the first cell, a configuration for the device to ignore an access barring check for the second cell, wherein the reestablishment procedure is configured to be performed by the device to redirect the communications to the second cell based at least in part on sending the configuration.

In certain aspects, method 1000 further includes sending, to the device via the first cell, cell information for a dedicated redirection cell, wherein the reestablishment procedure is configured to be performed by the device to redirect the communications to the second cell based at least in part on sending the cell information for the dedicated redirection cell, the second cell comprising the dedicated redirection cell.

In certain aspects, method 1000 further includes receiving, from the device via the first cell, an ordered list of one or more cells neighboring the first cell, wherein the ordered list of the one or more cells neighboring the first cell comprises the second cell.

In certain aspects, method 1000 further includes sending the RRC message comprising the indication configured to trigger the device to perform the reestablishment procedure to redirect the communications to the second cell based at least in part on receiving the ordered list.

In certain aspects, method 1000 further includes preparing the second cell for the reestablishment procedure based at least in part on receiving the ordered list.

In certain aspects, the ordered list of the one or more cells neighboring the first cell is received via an uplink transfer information message, an uplink DCCH message, or an uplink MAC CE.

In certain aspects, method 1000 further includes triggering the device to perform the reestablishment procedure to redirect the communications to the second cell based at least in part on a load balancing demand, identifying a coverage area for the first cell is moving away from the device, receiving assistance information from the device, or a combination thereof.

In certain aspects, the apparatus comprises a base station; and the device comprises a device operating in a control plane Internet of Things (IoT) optimization mode.

In certain aspects, the method 1000 further includes sending the RRC message comprising the indication configured to trigger the device to perform the reestablishment procedure to redirect the communications to the second cell and an NAS integrity protection parameter.

In certain aspects, the method 1000 further includes receiving, from the device via the second cell, a reestablishment request message based at least in part on sending the RRC message comprising the indication and the NAS integrity protection parameter, wherein the reestablishment request message comprises a response to the NAS integrity protection parameter.

In certain aspects, method 1000 may be performed by the apparatus to realize one or more technical effects or solutions to the aforementioned technical problem(s). For example, based on method 1000, the apparatus may decrease latency for the communications by indicating for the device to perform the reestablishment procedure to redirect the communications from the first cell to the second cell and, thus, preserving any pending uplink and/or downlink data at the device, which may have otherwise resulted in retransmissions for the apparatus to send the pending downlink data again and/or for the apparatus to reacquire the pending uplink data. Additionally, based on method 1000, the apparatus may increase reliability of the communications when indicating for the device to perform the reestablishment procedure to redirect the communications from the first cell to the second cell based on the device not losing the pending uplink and/or downlink data while performing the reestablishment procedure.

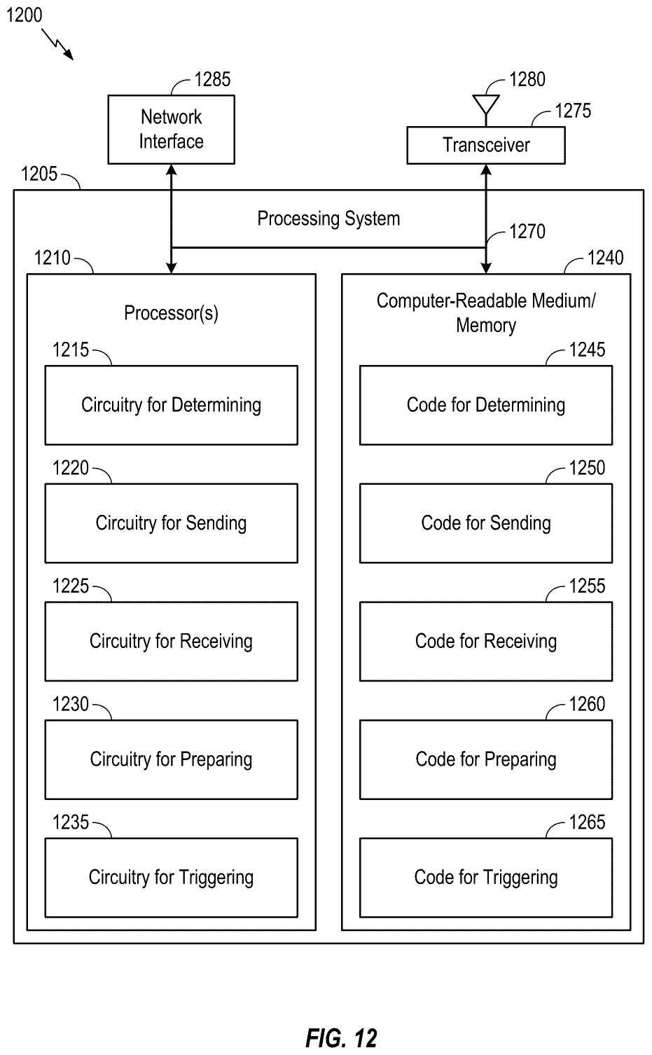

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to a transceiver 1165 (e.g., a transmitter and/or a receiver). The transceiver 1165 is configured to transmit and receive signals for the communications device 1100 via an antenna 1170, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1135 via a bus 1160. In certain aspects, the computer-readable medium/memory 1135 is configured to store instructions (e.g., computer-executable code) that when executed by the one or more processors 1110, enable and cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1135 stores code for receiving 1140, code for performing 1145, code for triggering 1150, and code for sending 1155. Processing of the code 1140-1155 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1135, including circuitry for receiving 1115, circuitry for performing 1120, circuitry for triggering 1125, and circuitry for sending 1130. Processing with circuitry 1115-1130 may enable and cause the communications device 1100 to perform the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1165 and/or antenna 1170 of the communications device 1100 in FIG. 11, and/or one or more processors 1110 of the communications device 1100 in FIG. 11. Means for communicating, receiving or obtaining may include the transceivers 354, antenna(s) 352, receive processor 358, AI processor 370, and/or controller/processor 380 of the UE 104 illustrated in FIG. 3, transceiver 1165 and/or antenna 1170 of the communications device 1100 in FIG. 11, and/or one or more processors 1110 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to a transceiver 1275 (e.g., a transmitter and/or a receiver) and/or a network interface 1285. The transceiver 1275 is configured to transmit and receive signals for the communications device 1200 via an antenna 1280, such as the various signals as described herein. The network interface 1285 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1240 via a bus 1270. In certain aspects, the computer-readable medium/memory 1240 is configured to store instructions (e.g., computer-executable code) that when executed by the one or more processors 1210, enable and cause the one or more processors 1210 to perform the method 1000 described with respect to FIG. 10, or any aspect related to it, including any operations described in relation to FIG. 10. Note that reference to a processor of communications device 1200 performing a function may include one or more processors of communications device 1200 performing that function, such as in a distributed fashion.

In the depicted example, the computer-readable medium/memory 1240 stores code for determining 1245, code for sending 1250, code for receiving 1255, code for preparing 1260, and code for triggering 1265. Processing of the code 1245-1265 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1240, including circuitry for determining 1215, circuitry for sending 1220, circuitry for receiving 1225, circuitry for preparing 1230, and circuitry for triggering 1235. Processing with circuitry 1215-1235 may enable and cause the communications device 1200 to perform the method 1000 described with respect to FIG. 10, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1275, antenna 1280, and/or network interface 1285 of the communications device 1200 in FIG. 12, and/or one or more processors 1210 of the communications device 1200 in FIG. 12. Means for communicating, receiving or obtaining may include the transceivers 332, antenna(s) 334, receive processor 338, AI processor 318, and/or controller/processor 340 of the BS 102 illustrated in FIG. 3, transceiver 1275, antenna 1280, and/or network interface 1285 of the communications device 1200 in FIG. 12, and/or one or more processors 1210 of the communications device 1200 in FIG. 12.

### EXAMPLE CLAUSES

Implementation examples are described in the following numbered clauses:
Clause 1: A method for wireless communications by an apparatus comprising: receiving, via a first cell, an RRC message comprising an indication to redirect communications via the first cell to a second cell; and performing a reestablishment procedure to redirect the communications to the second cell based at least in part on receiving the RRC message comprising the indication.
Clause 2: The method of Clause 1, wherein: the RRC message comprises an RRC release message; and the RRC release message comprises an IE used to indicate redirection of the communications to the second cell.
Clause 3: The method of Clause 2, wherein: the IE comprises a carrier frequency, a cell identifier, satellite information, a MIB, one or more SIBs, or a combination thereof for each cell of one or more cells to which the communications can be redirected; and the method further comprises selecting the second cell for redirecting the communications from the one or more cells indicated by the IE, the second cell selected based at least in part on a dedicated carrier offset, timer information, a threshold value, or a combination thereof.
Clause 4: The method of any one of Clauses 1-3, further comprising: triggering an RLF procedure for the communications via the first cell based at least in part on receiving the RRC message comprising the indication to redirect the communications; and sending, via the second cell, an RRC reestablishment request message based at least in part on triggering the RLF procedure.
Clause 5: The method of Clause 4, wherein the RRC reestablishment request message comprises a redirect indication, a reestablishment cause IE comprising the redirect indication, an LCID codepoint corresponding to the redirect indication, or a combination thereof.
Clause 6: The method of any one of Clauses 1-5, wherein: the RRC message comprises an RRC reestablishment message; and the RRC reestablishment message comprises an IE used to indicate redirection of the communications to the second cell.
Clause 7: The method of Clause 6, further comprising sending, via the second cell, an RRC connection reestablishment complete message based at least on performing the reestablishment procedure.
Clause 8: The method of Clause 6, wherein the RRC reestablishment message is received and the reestablishment procedure is triggered based at least in part on AS not being enabled for the communications via the first cell, a threshold to select the second cell being satisfied, or a combination thereof.
Clause 9: The method of Clause 6, wherein: the RRC reestablishment message also comprises a downlink NAS MAC IE and a dedicated radio resource configuration corresponding to the second cell; and the reestablishment procedure is performed to redirect the communications to the second cell based at least in part on the dedicated radio resource configuration corresponding to the second cell.
Clause 10: The method of any one of Clauses 1-9, further comprising: receiving, via the first cell, a configuration to ignore an access barring check for the second cell; and performing the reestablishment procedure to redirect the communications to the second cell based at least in part on receiving the configuration.
Clause 11: The method of any one of Clauses 1-10, further comprising: receiving, via the first cell, cell information for a dedicated redirection cell; and performing the reestablishment procedure to redirect the communications to the second cell based at least in part on receiving the cell information for the dedicated redirection cell, wherein the second cell comprises the dedicated redirection cell.
Clause 12: The method of any one of Clauses 1-11, further comprising: sending, via the first cell, an ordered list of one or more cells neighboring the first cell, the one or more cells neighboring the first cell being ordered based at least in part on measurements performed on the one or more cells; and receiving the RRC message comprising the indication to redirect the communications based at least in part on sending the ordered list.
Clause 13: The method of Clause 12, wherein the ordered list of the one or more cells neighboring the first cell is sent via an uplink transfer information message, an uplink DCCH message, or an uplink MAC-CE.
Clause 14: The method of any one of Clauses 1-13, wherein the apparatus comprises a device operating in a control plane Internet of Things (IoT) optimization mode.
Clause 15: The method of any one of Clauses 1-14, wherein the one or more processors are further configured to cause the apparatus to: receive the RRC message comprising the indication to redirect the communications and an NAS integrity protection parameter.
Clause 16: The method of Clause 15, wherein the one or more processors are further configured to cause the apparatus to: send, via the second cell, a reestablishment request message based at least in part on receiving the RRC message comprising the indication to redirect the communications and the NAS integrity protection parameter, wherein the reestablishment request message comprises a response to the NAS integrity protection parameter.
Clause 17: A method for wireless communications by an apparatus comprising: determining to redirect communications via a first cell to a second cell for a device; and sending, to the device via the first cell, an RRC message comprising an indication configured to trigger the device to perform a reestablishment procedure to redirect the communications to the second cell based at least in part on the determination.
Clause 18: The method of Clause 17, wherein: the RRC message comprises an RRC release message; and the RRC release message comprises an IE used to indicate redirection of the communications to the second cell.
Clause 19: The method of Clause 18, wherein the IE comprises a carrier frequency, a cell identifier, satellite information, a MIB, one or more SIBs, or a combination thereof for each cell of one or more cells to which the communications can be redirected for the device.
Clause 20: The method of any one of Clauses 17-19, further comprising: receiving, from the device via the second cell, an RRC reestablishment request message based at least in part on sending the RRC message comprising the indication via the first cell.
Clause 21: The method of Clause 20, wherein the RRC reestablishment request message comprises a redirect indication, a reestablishment cause IE comprising the redirect indication, an LCID codepoint corresponding to the redirect indication, or a combination thereof.
Clause 22: The method of any one of Clauses 17-21, wherein: the RRC message comprises an RRC reestablishment message; and the RRC reestablishment message comprises an IE used to indicate redirection of the communications to the second cell.
Clause 23: The method of Clause 22, further comprising receiving, from the device via the second cell, an RRC connection reestablishment complete message based at least on the device performing the reestablishment procedure after the RRC reestablishment message comprising the IE is sent to the device.
Clause 24: The method of Clause 22, wherein the RRC reestablishment message comprising the IE is sent to trigger the device to perform the reestablishment procedure based at least in part on AS not being enabled for the communications for the device via the first cell, a threshold to select the second cell being satisfied, or a combination thereof.
Clause 25: The method of Clause 22, wherein: the RRC reestablishment message also comprises a downlink NAS MAC IE and a dedicated radio resource configuration corresponding to the second cell; and the reestablishment procedure is configured to be performed by the device to redirect the communications to the second cell based at least in part on the dedicated radio resource configuration corresponding to the second cell.
Clause 26: The method of any one of Clauses 17-25, further comprising sending, to the device via the first cell, a configuration for the device to ignore an access barring check for the second cell, wherein the reestablishment procedure is configured to be performed by the device to redirect the communications to the second cell based at least in part on sending the configuration.
Clause 27: The method of any one of Clauses 17-26, further comprising sending, to the device via the first cell, cell information for a dedicated redirection cell, wherein the reestablishment procedure is configured to be performed by the device to redirect the communications to the second cell based at least in part on sending the cell information for the dedicated redirection cell, the second cell comprising the dedicated redirection cell.
Clause 28: The method of any one of Clauses 17-27, further comprising: receiving, from the device via the first cell, an ordered list of one or more cells neighboring the first cell, wherein the ordered list of the one or more cells neighboring the first cell comprises the second cell; and sending the RRC message comprising the indication configured to trigger the device to perform the reestablishment procedure to redirect the communications to the second cell based at least in part on receiving the ordered list.
Clause 29: The method of Clause 28, further comprising preparing the second cell for the reestablishment procedure based at least in part on receiving the ordered list.
Clause 30: The method of Clause 28, wherein the ordered list of the one or more cells neighboring the first cell is received via an uplink transfer information message, an uplink DCCH message, or an uplink MAC-CE.
Clause 31: The method of any one of Clauses 17-30, further comprising: triggering the device to perform the reestablishment procedure to redirect the communications to the second cell based at least in part on a load balancing demand, identifying a coverage area for the first cell is moving away from the device, receiving assistance information from the device, or a combination thereof.
Clause 32: The method of any one of Clauses 17-31, wherein: the apparatus comprises a base station; and the device comprises a device operating in a control plane Internet of Things (IoT) optimization mode.
Clause 33: The method of any one of Clauses 17-32, further comprising: sending the RRC message comprising the indication configured to trigger the device to perform the reestablishment procedure to redirect the communications to the second cell and an NAS integrity protection parameter.
Clause 34: The method of Clause 33, further comprising: receiving, from the device via the second cell, a reestablishment request message based at least in part on sending the RRC message comprising the indication and the NAS integrity protection parameter, wherein the reestablishment request message comprises a response to the NAS integrity protection parameter.
Clause 35: One or more apparatuses, comprising: one or more memories comprising executable instructions; and one or more processors configured to execute the executable instructions and cause the one or more apparatuses to perform a method in accordance with any one of Clauses 1-34.
Clause 36: One or more apparatuses, comprising: one or more memories; and one or more processors, coupled to the one or more memories, configured to cause the one or more apparatuses to perform a method in accordance with any one of Clauses 1-34.
Clause 37: One or more apparatuses, comprising: one or more memories; and one or more processors, coupled to the one or more memories, configured to perform a method in accordance with any one of Clauses 1-34.
Clause 38: One or more apparatuses, comprising means for performing a method in accordance with any one of Clauses 1-34.
Clause 39: One or more non-transitory computer-readable media comprising executable instructions that, when executed by one or more processors of one or more apparatuses, cause the one or more apparatuses to perform a method in accordance with any one of Clauses 1-34.
Clause 40: One or more computer program products embodied on one or more computer-readable storage media comprising code for performing a method in accordance with any one of Clauses 1-34.
Clause 41: A user equipment (UE), comprising: a processing system that includes processor circuitry and memory circuitry that stores code and is coupled with the processor circuitry, the processing system configured to cause the UE to perform a method in accordance with any one of Clauses 1-16.
Clause 42: A network entity, comprising: a processing system that includes processor circuitry and memory circuitry that stores code and is coupled with the processor circuitry, the processing system configured to cause the network entity to perform a method in accordance with any one of Clauses 17-34.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an Al processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories comprising processor-executable instructions; and one or more processors configured to execute the processor-executable instructions and cause the apparatus to:
receive, via a first cell, a radio resource control (RRC) message comprising an indication to redirect communications via the first cell to a second cell; and
perform a reestablishment procedure to redirect the communications to the second cell based at least in part on receiving the RRC message comprising the indication.

2. The apparatus of claim 1, wherein:
the RRC message comprises an RRC release message; and
the RRC release message comprises an information element (IE) used to indicate redirection of the communications to the second cell.

3. The apparatus of claim 2, wherein:
the IE comprises a carrier frequency, a cell identifier, satellite information, a master information block (MIB), one or more system information blocks (SIBs), or a combination thereof for each cell of one or more cells to which the communications can be redirected; and
the one or more processors are configured to cause the apparatus to select the second cell for redirecting the communications from the one or more cells indicated by the IE, the second cell selected based at least in part on a dedicated carrier offset, timer information, a threshold value, or a combination thereof.

4. The apparatus of claim 1, wherein the one or more processors are configured to cause the apparatus to:
trigger a radio link failure (RLF) procedure for the communications via the first cell based at least in part on receiving the RRC message comprising the indication to redirect the communications; and
send, via the second cell, an RRC reestablishment request message based at least in part on triggering the RLF procedure.

5. The apparatus of claim 4, wherein the RRC reestablishment request message comprises a redirect indication, a reestablishment cause IE comprising the redirect indication, a logical channel identifier (LCID) codepoint corresponding to the redirect indication, or a combination thereof.

6. The apparatus of claim 1, wherein:
the RRC message comprises an RRC reestablishment message; and
the RRC reestablishment message comprises an information element (IE) used to indicate redirection of the communications to the second cell.

7. The apparatus of claim 6, wherein the one or more processors are configured to cause the apparatus to send, via the second cell, an RRC connection reestablishment complete message based at least on performing the reestablishment procedure.

8. The apparatus of claim 6, wherein the RRC reestablishment message is received and the reestablishment procedure is triggered based at least in part on access stratum (AS) not being enabled for the communications via the first cell, a threshold to select the second cell being satisfied, or a combination thereof.

9. The apparatus of claim 6, wherein:
the RRC reestablishment message also comprises a downlink Non-Access stratum (NAS) medium access control (MAC) IE and a dedicated radio resource configuration corresponding to the second cell; and
the reestablishment procedure is performed to redirect the communications to the second cell based at least in part on the dedicated radio resource configuration corresponding to the second cell.

10. The apparatus of claim 1, wherein the one or more processors are configured to cause the apparatus to:
receive, via the first cell, a configuration to ignore an access barring check for the second cell; and
perform the reestablishment procedure to redirect the communications to the second cell based at least in part on receiving the configuration.

11. The apparatus of claim 1, wherein the one or more processors are configured to cause the apparatus to:
receive, via the first cell, cell information for a dedicated redirection cell; and
perform the reestablishment procedure to redirect the communications to the second cell based at least in part on receiving the cell information for the dedicated redirection cell, wherein the second cell comprises the dedicated redirection cell.

12. The apparatus of claim 1, wherein the one or more processors are configured to cause the apparatus to:
send, via the first cell, an ordered list of one or more cells neighboring the first cell, the one or more cells neighboring the first cell being ordered based at least in part on measurements performed on the one or more cells; and
receive the RRC message comprising the indication to redirect the communications based at least in part on sending the ordered list.

13. The apparatus of claim 12, wherein the ordered list of the one or more cells neighboring the first cell is sent via an uplink transfer information message, an uplink dedicated control channel (DCCH) message, or an uplink MAC control element (CE).

14. The apparatus of claim 1, wherein the apparatus comprises a device operating in a control plane Internet of Things (IoT) optimization mode.

15. The apparatus of claim 1, wherein the one or more processors are further configured to cause the apparatus to:
receive the RRC message comprising the indication to redirect the communications and a Non-Access Stratum (NAS) integrity protection parameter.

16. The apparatus of claim 15, wherein the one or more processors are further configured to cause the apparatus to:
send, via the second cell, a reestablishment request message based at least in part on receiving the RRC message comprising the indication to redirect the communications and the NAS integrity protection parameter, wherein the reestablishment request message comprises a response to the NAS integrity protection parameter.

17. A method for wireless communications by an apparatus comprising:
receiving, via a first cell, a radio resource control (RRC) message comprising an indication to redirect communications via the first cell to a second cell; and
performing a reestablishment procedure to redirect the communications to the second cell based at least in part on receiving the RRC message comprising the indication.

18. An apparatus configured for wireless communications, comprising: one or more memories comprising processor-executable instructions; and one or more processors configured to execute the processor-executable instructions and cause the apparatus to:
determine to redirect communications via a first cell to a second cell for a device; and
send, to the device via the first cell, a radio resource control (RRC) message comprising an indication configured to trigger the device to perform a reestablishment procedure to redirect the communications to the second cell based at least in part on the determination.

19. The apparatus of claim 18, wherein:
the RRC message comprises an RRC release message; and
the RRC release message comprises an information element (IE) used to indicate redirection of the communications to the second cell.

20. The apparatus of claim 19, wherein the IE comprises a carrier frequency, a cell identifier, satellite information, a master information block (MIB), one or more system information blocks (SIBs), or a combination thereof for each cell of one or more cells to which the communications can be redirected for the device.

21. The apparatus of claim 18, wherein the one or more processors are configured to cause the apparatus to:
receive, from the device via the second cell, an RRC reestablishment request message based at least in part on sending the RRC message comprising the indication via the first cell.

22. The apparatus of claim 21, wherein the RRC reestablishment request message comprises a redirect indication, a reestablishment cause IE comprising the redirect indication, a logical channel identifier (LCID) codepoint corresponding to the redirect indication, or a combination thereof.

23. The apparatus of claim 18, wherein:
the RRC message comprises an RRC reestablishment message; and
the RRC reestablishment message comprises an information element (IE) used to indicate redirection of the communications to the second cell.

24. The apparatus of claim 23, wherein the one or more processors are configured to cause the apparatus to receive, from the device via the second cell, an RRC connection reestablishment complete message based at least on the device performing the reestablishment procedure after the RRC reestablishment message comprising the IE is sent to the device.

25. The apparatus of claim 23, wherein the RRC reestablishment message comprising the IE is sent to trigger the device to perform the reestablishment procedure based at least in part on access stratum (AS) not being enabled for the communications for the device via the first cell, a threshold to select the second cell being satisfied, or a combination thereof.

26. The apparatus of claim 18, wherein the one or more processors are configured to cause the apparatus to:
receive, from the device via the first cell, an ordered list of one or more cells neighboring the first cell, wherein the ordered list of the one or more cells neighboring the first cell comprises the second cell; and
send the RRC message comprising the indication configured to trigger the device to perform the reestablishment procedure to redirect the communications to the second cell based at least in part on receiving the ordered list.

27. The apparatus of claim 26, wherein the one or more processors are configured to cause the apparatus to prepare the second cell for the reestablishment procedure based at least in part on receiving the ordered list.

28. The apparatus of claim 18, wherein the one or more processors are configured to cause the apparatus to:
trigger the device to perform the reestablishment procedure to redirect the communications to the second cell based at least in part on a load balancing demand, identifying a coverage area for the first cell is moving away from the device, receiving assistance information from the device, or a combination thereof.

29. The apparatus of claim 18, wherein:
the apparatus comprises a base station; and
the device comprises a device operating in a control plane Internet of Things (IoT) optimization mode.

30. A method for wireless communications by an apparatus comprising:
determining to redirect communications via a first cell to a second cell for a device; and
sending, to the device via the first cell, a radio resource control (RRC) message comprising an indication configured to trigger the device to perform a reestablishment procedure to redirect the communications to the second cell based at least in part on the determination.
